(19) United States
(12) Patent Application Publication
(10) Pub. No.: US 2026/0183747 A1
(43) Pub. Date: Jul. 2, 2026

(54) AMINE-FLUORINE BIFUNCTIONAL HYDROGEL ADSORBENT, AND PREPARATION AND APPLICATION THEREOF

(71) Applicant: Shanghai Jiao Tong University, Shanghai (CN)

(72) Inventors: Jinming Luo, Shanghai (CN); Kaixing Fu, Shanghai (CN); Jinjing Huang, Shanghai (CN); Chunyu Lv, Shanghai (CN)

(21) Appl. No.: 19/177,635

(22) Filed: Apr. 14, 2025

(30) Foreign Application Priority Data
Sep. 6, 2024 (CN) 202411249441.5

(51) Int. Cl. B01J 20/28; B01J 20/24; B01J 20/30; C02F 1/28; C02F 101/36; C02F 103/00

(52) U.S. Cl. CPC B01J 20/28047; B01J 20/24; B01J 20/3078; C02F 1/285; B01J 2220/44; B01J 2220/4825; C02F 2101/36; C02F 2103/007; C02F 2307/14

(57) ABSTRACT

The present invention relates to the technical field of pollutant treatment, in particular to an amine-fluorine bifunctional hydrogel adsorbent, and preparation and use thereof. The present invention provides a preparation method of an amine-fluorine bifunctional hydrogel adsorbent, which comprises the following steps: uniformly mixing a fluorine-containing alkene monomer, a quaternary ammonium salt alkene monomer, a traditional Chinese medicine residue cellulose dispersion liquid, N,N′-methylene bisacrylamide and ammonium persulfate, and sequentially carrying out heating reaction, deionized water swelling and drying to obtain the amine-fluorine bifunctional hydrogel adsorbent. According to the present invention, the quaternary ammonium salt alkene monomer is introduced as a hydrophilic monomer, and the fluorine-containing alkene monomer is introduced as a hydrophobic monomer, so that the amine-fluorine bifunctional hydrogel adsorbent has a hydrophilic amine and hydrophobic fluorine dual-network interpenetrating porous structure, and the structure enhances water transmission and the mass transfer rate of a per- nd polyfluoroalkyl substance.

### CROSS REFERENCE TO RELATED APPLICATIONS

This application claims foreign priority of Chinese Patent Application No. 202411249441.5, filed on Sep. 6, 2024 in the China National Intellectual Property Administration, the disclosures of all of which are hereby incorporated by reference.

### TECHNICAL FIELD

The present invention relates to the technical field of pollutant treatment, in particular to an amine-fluorine bifunctional hydrogel adsorbent, and preparation and use thereof.

### BACKGROUND OF THE PRESENT INVENTION

Per-and perfluoroalkyl substances (PFAS) are a class of novel organic fluorides synthesized artificially in the late 1940s, consisting of a hydrophobic perfluoroalkyl chain and a hydrophilic ion head. Because of hydrophobic and oleophobic properties and high stability, the substances have been widely used in all walks of life since the successful synthesis, such as textiles, lubrication, surfactants, food packaging, non-stick coatings, electronic products, fire-fighting foams and other fields, causing serious environmental pollution.

In recent years, more and more studies have focused on materials with an aminated structure, and the aminated adsorption materials can improve an electrostatic adsorption effect to the PFAS through a rearrangement effect of electrons, thus being expected to achieve selective adsorption to the PFAS.

The patent application with the publication number CN115386136A discloses an aminated polyacrylamide foam adsorbent with a porous structure and a high specific surface area, wherein an aminated group on a surface of the adsorbent can improve the electrostatic adsorption effect to the per-and perfluoroalkyl substances. However, an amine group basing on electrostatic adsorption is easily influenced by anions (such as nitrate, chloride and sulfate) coexisting in water, and the amido adsorbent does not have a specific adsorption functional group structure, leading to the failure of selective adsorption and the decrease of adsorption efficiency and adsorption capability.

Therefore, it is the key to obtain a PFAS adsorbent capable of realizing efficient selective adsorption currently.

### SUMMARY OF THE PRESENT INVENTION

The present invention aims to overcome the defect that an aminated adsorbent in the prior art cannot realize selective adsorption due to an influence of anions coexisting in water to amine group, and provide an amine-fluorine bifunctional hydrogel adsorbent, and preparation and use thereof to overcome the above defect.

In order to achieve the above objectives, the present invention provides the following technical solutions.

The present invention provides a preparation method of an amine-fluorine bifunctional hydrogel adsorbent, comprising: uniformly mixing a fluorine-containing alkene monomer, a quaternary ammonium salt alkene monomer, a traditional Chinese medicine residue cellulose dispersion liquid, N,N′-methylene bisacrylamide and ammonium persulfate, and sequentially carrying out heating reaction, deionized water swelling and drying to obtain the amine-fluorine bifunctional hydrogel adsorbent.

On the basis of an existing aminated adsorbent, a hydrophobic fluorine chain structure is introduced in the present application to improve a targeted adsorption capability of the adsorbent to PFAS, thus solving the interference problem of anions coexisting in water.

Specifically, the quaternary ammonium salt alkene monomer is used as a hydrophilic monomer, the fluorine-containing alkene monomer is used as a hydrophobic monomer, and there is a hydrophilic and hydrophobic alternating polymerization property during free radical polymerization, which avoids excessive monomer aggregation during polymerization, and a hydrogel finally formed with traditional Chinese medicine residue cellulose has a dispersed fiber bundle network. This polymerization property promotes the amine-fluorine bifunctional hydrogel adsorbent to form a highly dispersed porous interpenetrating network structure, and meanwhile, a large number of N and F loads are interweaved to enter the porous interpenetrating network structure during the free radical polymerization, so that the finally obtained adsorbent has a large number of amination sites and fluorination sites. More importantly, the two monomers are not layered due to a hydrophilicity and hydrophobicity difference, but polymerized synchronously during synthesis, thus forming a porous dual-network gel structure with uniform site distribution.

The unique hydrophilic amine and hydrophobic fluorine dual-network interpenetrating porous structure of the synthesized amine-fluorine bifunctional hydrogel adsorbent enhances the water transmission and a mass transfer rate of PFAS molecules. The amination and fluorination sites in high density provide sufficient anchor sites for targeted adsorption to the PFAS. In addition, the amination sites and the fluorination sites may capture anionic oxygen ends and fluorocarbon chain ends of the PFAS molecules respectively through amine-fluorine bifunctional sites constructed according to the structural feature orientation of PFAS molecules, and finally, the PFAS in water are efficiently and selectively removed.

Furthermore, according to measurement of a pore size of the amine-fluorine bifunctional hydrogel adsorbent, the pore size is in a nano-scale, and mainly ranges from 4 nm to 24 nm, showing a uniform distribution characteristic of mesopores; and a pore size of the nano-scale mesopores may assist in obtaining more sites contacting with the PFAS, and the transmission of the PFAS molecules can be promoted in combination with a macroporous characteristic of a gel matrix, thus realizing rapid selective adsorption.

In addition, the applicant measured the adsorption capability of the adsorbent, and results showed that: an adsorption capability of an aminated gel adsorbent without F doping in deionized water is slightly stronger than that of the amine-fluorine bifunctional hydrogel adsorbent; while in tap water and lake water matrices, the amine-fluorine bifunctional hydrogel adsorbent shows a stronger adsorption capability and a higher adsorption capacity. Therefore, the introduction of a fluorine chain can effectively solve the interference problem of anions coexisting in water; and in the face of complex water bodies in practical application, the amine-fluorine bifunctional hydrogel adsorbent can realize truly efficient selective adsorption because of a special structure and a site function.

To sum up, according to the preparation method provided by the present application, a dual-network interpenetrating porous structure with small pores may be synthesized, which provides more contact space for the PFAS and the adsorbent, and the porous interpenetrating structure may selectively intercept the PFAS under an effect of amine-fluorine bifunctional sites, thus realizing better and faster PFAS adsorption.

Preferably, the fluorine-containing alkene monomer is hexafluorobutyl methacrylate, 1H,1H,5H-octafluoropentyl methacrylate, 1H,1H,2H,2H-nonafluorohexyl methacrylate or 2,2,3,3,4,4,5,5,6,6,7,7-dodecafluoroheptyl methacrylate.

Preferably, the quaternary ammonium salt alkene monomer is methacryloyloxyethyltrimethyl ammonium chloride.

Preferably, a molar ratio of a fluorine content in the fluorine-containing alkene monomer to a nitrogen content in the quaternary ammonium salt alkene monomer, the N,N′-methylene bisacrylamide and the ammonium persulfate is 4 to 18:2 to 6:0.065 to 0.195:0.022 to 0.088, and a molar volume ratio of the N,N′-methylene bisacrylamide to the traditional Chinese medicine residue cellulose dispersion liquid is 0.065 to 0.195 mmol:1 to 3 mL.

Further preferably, the molar ratio of the fluorine content in the fluorine-containing alkene monomer to the nitrogen content in the quaternary ammonium salt alkene monomer, the N,N′-methylene bisacrylamide and the ammonium persulfate is 5 to 10:3 to 6:0.13 to 0.18:0.03 to 0.07.

Further preferably, the molar ratio of the fluorine content in the fluorine-containing alkene monomer to the nitrogen content in the quaternary ammonium salt alkene monomer, the N,N′-methylene bisacrylamide and the ammonium persulfate is 9:4:0.1365:0.044.

Further preferably, the molar volume ratio of the N,N′-methylene bisacrylamide to the traditional Chinese medicine residue cellulose dispersion liquid is 0.13 to 0.18 mmol:2 mL.

Preferably, the temperature for the heating reaction is frome 60° C. to 80° C., and the time for the heating reaction is from 2 hours to 6 hours.

Further preferably, the temperature for the heating reaction is 70° C., and the time for the heating reaction is 4 hours.

Preferably, the time for the swelling is from 1 hour to 3 hours, the temperature for the drying is from 50° C. to 80° C., and the time for the drying is from 24 hours to 72 hours.

Further preferably, the time for the swelling is 2 hours, the temperature for the drying is 60° C., and the time for the drying is 36 hours.

Preferably, a preparation method of the traditional Chinese medicine residue cellulose dispersion liquid comprises the following steps: heating a traditional Chinese medicine residue waste, potassium peroxymonosulfate and water for oxidation reaction, then stopping heating and diluting and washing with water to obtain traditional Chinese medicine residue cellulose, and dispersing the traditional Chinese medicine residue cellulose in dimethylformamide to obtain the traditional Chinese medicine residue cellulose dispersion liquid.

Preferably, the traditional Chinese medicine residue waste is a radix paeoniae rubra residue and/or a rhizoma acori graminei residue, a mass ratio of a dry weight of the traditional Chinese medicine residue waste to potassium peroxymonosulfate is 1:5 to 20:100, the temperature for the heating is from 20° C. to 100° C., and the time for the heating is from 2 hours to 48 hours.

Preferably, the mixture is diluted with water 10 times.

Preferably, a dispersion mode is ultrasonic dispersion.

The present invention further provides an amine-fluorine bifunctional hydrogel adsorbent prepared by the preparation method above.

Preferably, the amine-fluorine bifunctional hydrogel adsorbent has a hydrophilic amine and hydrophobic fluorine dual-network interpenetrating porous structure.

According to measurement of a pore size of the amine-fluorine bifunctional hydrogel adsorbent, the pore size is in a nano-scale, and mainly ranges from 4 nm to 24 nm.

The present invention further provides a use of the amine-fluorine bifunctional hydrogel adsorbent in selective adsorption to a per- and polyfluoroalkyl substance.

Therefore, the present invention has the following beneficial effects.
(1) According to the present application, the quaternary ammonium salt alkene monomer is introduced as the hydrophilic monomer, and the fluorine-containing alkene monomer is introduced as the hydrophobic monomer, so that the amine-fluorine bifunctional hydrogel adsorbent has the hydrophilic amine and hydrophobic fluorine dual-network interpenetrating porous structure, and the structure enhances the water transmission and a mass transfer rate of PFAS molecules.
(2) According to the present application, N⁺ of the quaternary ammonium salt and F⁻ of the fluorine-containing alkene monomer are introduced into the porous structure at the stage of free radical polymerization, so that it is guaranteed that the amination and fluorination sites in high density provide sufficient anchor sites for targeted adsorption to the PFAS while realizing ultra-high loading of N and F elements. In addition, the amination sites and the fluorination sites may capture the anionic oxygen ends and the fluorocarbon chain ends of the PFAS molecules respectively through the amine-fluorine bifunctional sites constructed according to the structural feature orientation of PFAS molecules, and finally, the PFAS in water are efficiently and selectively removed.
(3) According to the preparation method provided by the present application, the density of the amination and fluorination sites in the amine-fluorine bifunctional hydrogel may be accurately adjusted by changing an adding ratio of amination monomers to fluorination monomers, thus having the advantage of controllable composition.
(4) The amine-fluorine bifunctional hydrogel adsorbent provided by the present application has both electropositive quaternary ammonium salt and fluorinated long-chain molecular structures, and provides the electrostatic sites and the fluorophilic sites respectively during PFAS adsorption, so that two ends of the PFAS molecules may be captured at the same time, thus realizing selective and efficient removal of the PFAS in water.
(5) The amine-fluorine bifunctional hydrogel adsorbent provided by the present application has an interpenetrating porous structure with a uniform size, and has both mesopore and macropore characteristics, thus being beneficial for enhancing the mass transfer of the PFAS molecules and the water transmission rate.
(6) The amine-fluorine bifunctional hydrogel adsorbent provided by the present application has good adsorption and removal effects on various PFAS, and adsorption and removal rates are close to 100%.

### DESCRIPTION OF THE DRAWINGS

FIG. 1a, FIG. 1b, FIG. 1c, FIG. 1d and FIG. 1e show SEM images of a hydrogel adsorbent, wherein a is QA, b is QF6, c is QF8, d is QF9, and e is QF12;

FIG. 2a, FIG. 2b and FIG. 2c show SEM and EDS images of QF6, wherein a is an SEM image of QF6, b is an EDS image of an N element, and c is an EDS image of an F element;

FIG. 3 is a diagram showing changes of contents of N and F elements in QA, QF6, QF8, QF9 and QF12;

FIG. 4a and FIG. 4b show diagrams of BET results, wherein a is a nitrogen adsorption-desorption curve and b is a pore size distribution curve;

FIG. 5a, FIG. 5b and FIG. 5c show comparison diagrams of adsorption capacities of QA, QF6, QF8, QF9 and QF12 to PFAS in different water bodies, wherein a is deionized water, b is tap water and c is lake water;

FIG. 6a, FIG. 6b, FIG. 6c and FIG. 6d show comparison diagrams of removal rates of PFAS in deionized water (DW), tap water (TW) and lake water (LW) by QA, QF6, QF8, QF9 and QF12, wherein a is PFOS, b is PFOA, c is PFBS and d is GenX;

FIG. 7a and FIG. 7b show removal rates of PFAS in different water bodies by QF6 under different pH conditions, wherein a is deionized water and b is lake water;

FIG. 8a, FIG. 8b, FIG. 8c and FIG. 8d show adsorption kinetic curves of PFAS in lake water by QF6, wherein a is PFOS, b is PFOA, c is PFBS and d is GenX; and

FIG. 9 is a diagram showing an adsorption cycle performance of QF6 to four PFAS in lake water.

### DETAILED DESCRIPTION OF PREFERRED EMBODIMENTS

The present invention is further described hereinafter with reference to specific embodiments. Those ordinary skills in the art will be able to implement the present invention based on these descriptions. In addition, the embodiments of the present invention referred to in the following descriptions are a part of, rather than all of, the embodiments of the present invention. Therefore, based on the embodiments in the present invention, all other embodiments obtained by those ordinary skills in the art without going through any inventive work shall fall within the scope of protection of the present invention.

### EXAMPLES

Raw materials used in this part comprise:
hexafluorobutyl methacrylate (F6): CAS NO36405-47-7, molecular formula: C₈H₈F₆O₂;
1H,1H,5H-octafluoropentyl methacrylate (F8): CAS NO 355-93-1, molecular formula: C₈H₆F₈O₂;
1H,1H,2H,2H-nonafluorohexyl methacrylate (F9): CAS NO 1799-84-4, molecular formula: C₁₀H₉F₉O₂;
2,2,3,3,4,4,5,5,6,6,7,7-dodecafluoroheptyl methacrylate (F12): CAS NO2261-99-6, molecular formula: C₁₁H₈F₁₂O₂;
methacryloyloxyethyltrimethyl ammonium chloride (N+): CAS NO5039-78-1, molecular formula: C₉H₁₈ClNO₂;
N,N′-methylene bisacrylamide (MBA): CAS NO110-26-9, molecular formula: C₇H₁₀N₂O₂;
ammonium persulfate (APS): CAS NO7727-54-0, molecular formula: H₈N₂O₈S₂;
potassium perfluorooctyl sulfonate (PFOS): CAS NO2795-39-3, molecular formula: C₈F₁₇KO₃S;
perfluorooctanoic acid (PFOA): CAS NO335-67-1, molecular formula: C₈HF₁₅O₂;
potassium perfluorobutyl sulfonate (PFBS): CAS NO29420-49-3, molecular formula: C₄F₉KO₃S;
perfluoro(2-methyl-3-oxahexanoic)acid (GenX): CAS NO13252-13-6, molecular formula: C₆HF₁₁O₃;
N,N-dimethylformamide (DMF): CAS NO68-12-2, molecular formula: C₃H₇NO;
Potassium peroxymonosulfate (PMS): CAS NO70693-62-8, molecular formula: HKO₆S.

### Example 1

### 1. Preparation of Traditional Chinese Medicine Residue Cellulose Dispersion Liquid

(1) 1 g of dried radix paeoniae rubra residue was added into a beaker containing 100 mL of distilled water and stirred for 10 minutes, then PMS was added into the distilled water until a concentration of the PMS was 0.3 mol/L and stirred at 800 rpm and 80° C. for 10 hours, then the heating was stopped, and distilled water was added for dilution to terminate the reaction, wherein a volume ratio of dilution was 1:10.
(2) The diluted reaction solution was allowed to stand and then an upper-layer supernatant was removed, the above operation was repeated for 5 times until the upper-layer supernatant was neutral, the supernatant was removed, and a precipitate was centrifugally separated at 10000 rpm to obtain a traditional Chinese medicine residue cellulose solution.
(3) The obtained high-purity traditional Chinese medicine residue cellulose solution was dispersed in a DMF solution, and the above traditional Chinese medicine residue cellulose solution was ultrasonically treated for 15 minutes by a cell crusher (1800 W, 90%) to obtain the highly dispersed traditional Chinese medicine residue cellulose dispersion liquid.

### 2. Preparation of Amine-Fluorine Bifunctional Hydrogel

(1) 4 mmol N+, 1.5 mmol F6 and 2 mL the traditional Chinese medicine residue cellulose dispersion liquid, and 0.021 g MBA and 0.01 g APS were respectively added into a 5 mL plastic centrifuge tube; and a magnetic stirring bar was added to stir the mixture for 10 minutes by magnetic stirring.
(2) The centrifuge tube filled with the precursor solution was transferred to a preheated electric oven to react at 70° C. for 4 hours.
(3) After the reaction, a hydrogel obtained by the reaction was cut into small pieces, fully swollen in deionized water for 2 hours, fully moistened and washed with deionized water for 3 times, and then dried in an electric oven at 60° C. for 36 hours to obtain a QF6 hydrogel.

### Example 2

This example was basically the same as Example 1, except that: 1.5 mmol F6 was replaced by 1.125 mmol F8, so as to obtain a QF8 hydrogel.

### Example 3

This example was basically the same as Example 1, except that: 1.5 mmol F6 was replaced by 1.0 mmol F9, so as to obtain a QF9 hydrogel.

### Example 4

This example was basically the same as Example 1, except that: 1.5 mmol F6 was replaced by 0.75 mmol F12, so as to obtain a QF12 hydrogel.

### Comparative Example 1 (Including N and Excluding F)

This comparative example was basically the same as Embodiment 1, except that: F6 was not added, so as to obtain a QA hydrogel.

### Performance Test

### 1. Test by Scanning Electron Microscope (SEM) and Energy Dispersive Spectrometer (EDS)

Determination method: QA/QF6/QF8/QF9/QF12 was fully swollen in water, then quickly and fully frozen by liquid nitrogen, then transferred to an ultra-low-temperature refrigerator at −70° C. to fully freeze for 6 hours, and subsequently put into a freeze dryer to dry for 12 hours to wait for the SEM test; and (2) the SEM and EDS tests were carried out by the scanning electron microscope (FlexSEM1000II, Hitachi).

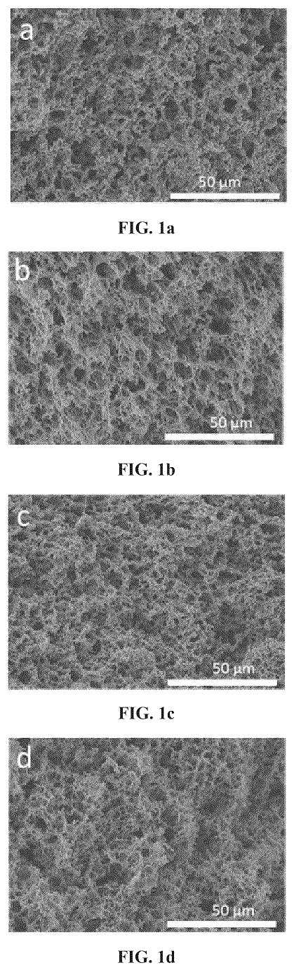

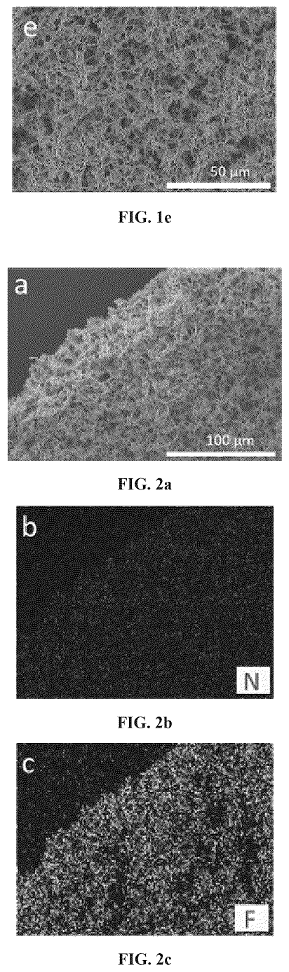

Determination results were shown in FIG. 1a, FIG. 1b, FIG. 1c, FIG. 1d and FIG. 1e and FIG. 2a, FIG. 2b and FIG. 2c. By observing FIG. 1a, FIG. 1b, FIG. 1c, FIG. 1d and FIG. 1e, it could be seen from the SEM image of FIG. 1a that an interior of the QA gel was mainly composed of granular polymers, and these particles were agglomerated and stacked to finally form a porous structure. The formation of these particles could reduce the permeability of water in the interior of the QA and reduce the probability of capturing the PFAS by QA adsorption sites. FIG. 1b to FIG. 1e were SEM images of QF6, QF8, QF9 and QF12 respectively. It could be seen that the prepared QF series amine-fluoride bifunctional hydrogels all showed a porous network structure, and the interiors of the hydrogels showed a dispersed fiber bundle network. Because a quaternary ammonium salt monomer and a fluorine chain monomer respectively had hydrophilic and hydrophobic properties, there was a hydrophilic and hydrophobic alternating polymerization property during free radical polymerization, which avoided excessive monomer aggregation during polymerization, and a finally formed hydrogel had the dispersed fiber bundle network. This polymerization property promoted the QF series gels to form a highly dispersed porous interpenetrating network structure, thus promoting the water transmission and the mass transfer of PFAS molecules.

FIG. 2a, FIG. 2b and FIG. 2c showed EDS images corresponding to the QF6. It could be observed that: in the QF6 hydrogel, N and F elements derived from the quaternary ammonium salt monomer and the fluorine chain monomer were uniformly distributed in the interior of the hydrogel, indicating that the precursor solution was uniformly mixed, the two monomers were not layered due to a hydrophilicity and hydrophobicity difference, and the two monomers were synchronously polymerized during synthesis, thus forming a porous dual-network gel structure with uniform site distribution.

### 2. Determination by Elemental Analyzer

The QA/QF6/QF8/QF9/QF12 was fully crushed by a pulverizer, sieved by a 60-mesh sieve and then collected to wait for elemental analysis and determination; and C, H and N elements in the hydrogel were analyzed by the elemental analyzer (Vario EL Cube, ELEMENT).

In order to ensure the performance comparison of QF gels modified by different fluorine chain monomers (F6, F8, F9 and F12) under the same amine site and fluorine site equivalent conditions, different QF gel materials with the same theoretical equivalent of N and F elements were prepared by regulating the amounts of different fluorine chain monomers and controlling the amounts of quaternary ammonium salt monomers to be the same during the synthesis of the QF gels.

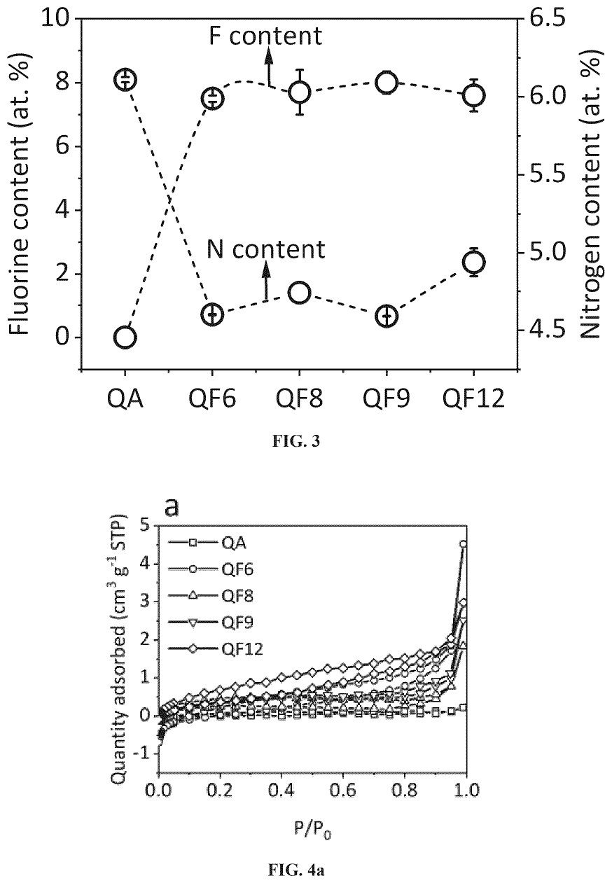

FIG. 3 showed results of element contents actually measured by the SEM-EDS and the element analyzer. It could be seen from the figure that the N and F elements in QF6, QF8, QF9 and QF12 were both kept at the same levels, wherein the content of N element was about 4.6 at. % to 4.9 at. % and the content of F element was about 7.5 at. % to 8.0 at. %. As a comparative example, a QA gel synthesized without adding an F chain monomer did not contain F element, wherein the content of N element was about 6.1 at. %.

### 3. Tests of Nitrogen Adsorption-Desorption Curve and Pore Size Distribution Curve

Determination method: the prepared QA/QF6/QF8/QF9/QF12 was fully swollen in water, then quickly and fully frozen by liquid nitrogen, then transferred to an ultra-low-temperature refrigerator at −70° C. to fully freeze for 6 hours, and subsequently put into a freeze dryer to dry for 12 hours to wait for BET determination; and the test of nitrogen adsorption-desorption curve was carried out by a specific surface area and pore size analyzer (Quantachrome NovaWin, ASIQM0000-5, USA), and before the test, a test sample was activated and degassed in vacuum at a temperature controlled at 80° C. for 10 hours.

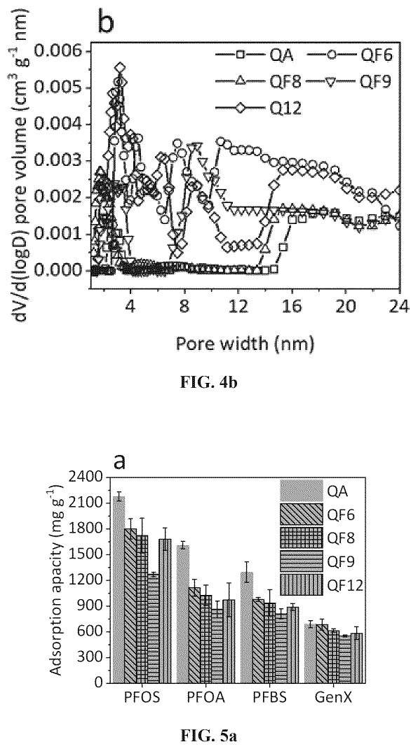

FIG. 4a showed nitrogen adsorption-desorption curves of aminated gel QA and amine-fluorine bifunctional QF gel materials. According to the results of BET determination, specific surface areas of QA, QF6, QF8, QF9 and QF12 were 0.174 m²/g, 0.131 m²/g, 0.981 m²/g, 1.582 m²/g and 1.651 m²/g respectively, and the specific surface areas of the QF gels were increased with the increase of chain length of the fluorine chain monomer.

FIG. 4b was a pore size distribution diagram of various gel materials. It could be seen from the figure that pore sizes of QA and QF8 were mainly concentrated at 2 nm and 15 nm to 24 nm, while QF6, QF9 and QF12 showed hierarchical porous property in a mesoporous region, wherein QF6 and QF12 showed wide pore size distribution in a range of 3 nm to 20 nm, and the pore size of QF9 was mainly concentrated at 3 nm and 9 nm.

### 4. Determination of Adsorption Capacity to PFAS

### Determination Method:

(1) 5 mg QA/QF6/QF8/QF9/QF12 material was added into a polypropylene sample bottle filled with 100 mL of 150 mg/L PFAS (PFOS, PFOA, PFBS and GenX) deionized water solution, then the sample bottle was put into a constant-temperature shaker and shaken at 180 rpm and 25° C. for 48 hours, 1.5 mL of adsorbed solution was sucked, filtered by a needle filter made of polypropylene and diluted for a certain number of times, then 100 μL of supernatant was taken to measure the concentration of PFAS in the supernatant, and an adsorption capacity of each material to the PFAS was calculated.
(2) By using the method in the step (1) for reference, the deionized water was changed into tap water, and the adsorption capacity to the PFAS was determined without changing other experimental processes and steps.
(3) By using the method in the step (1) for reference, the deionized water was changed into lake water, and the adsorption capacity to the PFAS was determined without changing other experimental processes and steps.

A total of three parallel tests were carried out in the above experiments to ensure the accuracy of test results.

In order to explore the influence of fluorination on the selectivity of adsorption of the gels to the PFAS, adsorption capacities of the aminated gel QA and the amine-fluoride bifunctional QF gel to four PFAS in three different water bodies were compared.

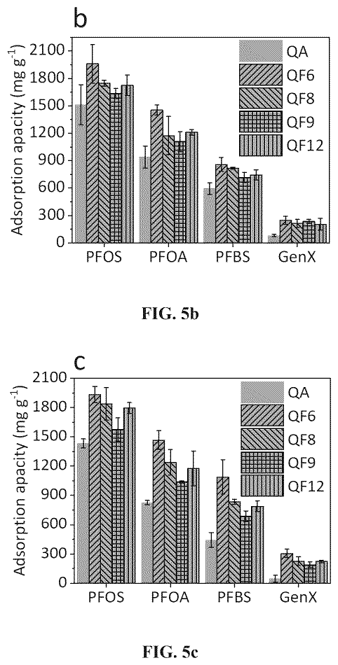

FIG. 5a showed the adsorption capacities of the prepared gel materials to four PFAS in the deionized water. It could be observed that: the adsorption capacities of the QA to PFOS, PFOA, PFBS and GenX in the deionized water were 2178 mg/g, 1609 mg/g, 1294 mg/g and 690 mg/g respectively, which obviously exceeded the adsorption capacities of the QF series gels to the four PFAS. This was because that the QA had higher hydrophilicity, which increased an interface contact between water molecules and the gel, thus being beneficial for a PFAS adsorption process.

However, in actual water bodies, some anions and cations could compete with PFAS molecules for adsorption sites on the gel materials, resulting in a decrease of adsorption capacity to PFAS. As shown in FIG. 5b and FIG. 5c, the adsorption capacities of QA to the four PFAS in tap water and lake water were obviously lower than those in deionized water, which was due to the influence of interferents coexisting in water. Comparatively speaking, the adsorption capacities of QF series gels to PFOS and PFOA were significantly increased instead of being decreased. In tap water, the adsorption capacities of QF6 to PFOS and PFOA were increased by 8.9% and 30.5% respectively. However, the adsorption capacities of QF gel to PFBS and GenX were decreased partially. In tap water, the adsorption capacities of QF6 to PFBS and GenX were decreased by 12.1% and 63.8% respectively. The adsorption capacities of QA gel to PFBS and GenX were also decreased significantly, by 54.0% and 88.4% respectively. Comparatively speaking, tap water had little influence on the QF6 gel.

The above results showed that the introduction of fluorine chain structure into the aminated gel effectively enhanced the selective adsorption performances of the gel materials to the PFAS in actual water bodies. It was worth noting that, in the four QF gel materials, QF6 had the highest adsorption capacity. The adsorption capacities of the QF6 to PFOS, PFOA, PFBS and GenX in the lake water matrix were 1932 mg/g, 1467 mg/g, 1089 mg/g and 306 mg/g respectively.

### 5. Determination of Removal Rate of PFAS

### Determination Method:

(1) 3 mg of QA/QF6/QF8/QF9/QF12 material was added into a polypropylene sample bottle filled with 30 mL of 10 μg/L PFAS deionized water solution, then the sample bottle was put into a constant-temperature shaker and shaken at 180 rpm and 25° C. for 12 hours, 1.5 mL of adsorbed solution was sucked, filtered by a needle filter made of polypropylene, then 100 μL of supernatant was taken to measure a concentration of PFAS in the supernatant, and the removal rate of PFAS by each material was calculated.
(2) By using the method in the step (1) for reference, the deionized water was changed into tap water, and the removal rate of PFAS was determined without changing other experimental processes and steps.
(3) By using the method in the step (1) for reference, the deionized water was changed into lake water, and the removal rate of PFAS was determined without changing other experimental processes and steps.

A total of three parallel tests were carried out in the above experiments to ensure the accuracy of test results.

In order to further explore the influence of fluorination on the selective removal of PFAS by the gels at environmentally relevant concentrations, removal rates of the four PFAS by the aminated gel QA and the amine-fluoride bifunctional QF gels in three different water bodies were compared.

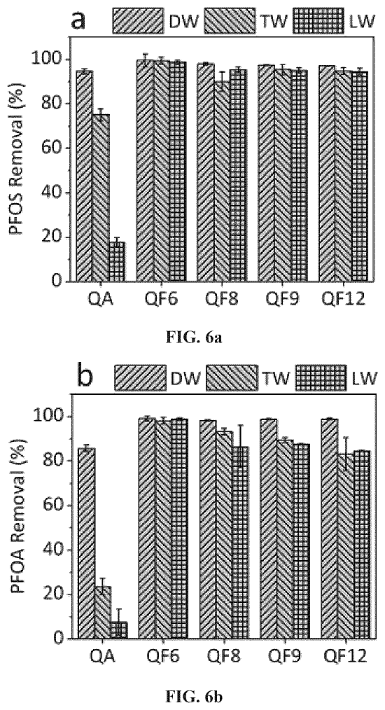

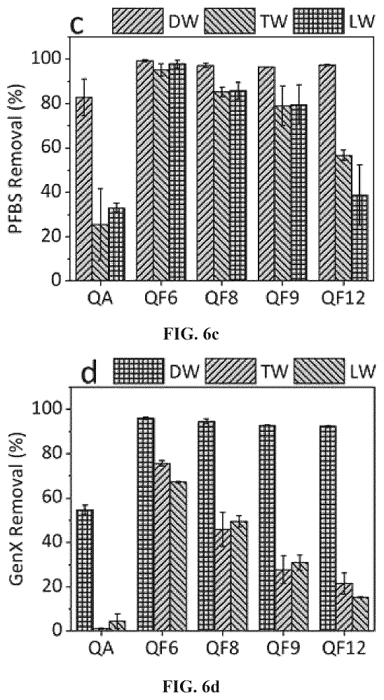

The results were shown in FIG. 6a to FIG. 6d, and the removal rate of PFAS by QA was significantly affected by the water matrix. Compared with deionized water system, tap water and lake water significantly affected the PFAS removal performance of QA, wherein the removal rates of PFOS, PFOA, PFBS and GenX by QA in the lake water were lower than 20.0%, 10.0%, 40.0% and 10.0% respectively. Compared with QA, the influence of the water matrix on the PFAS removal by QF series amine-fluoride bifunctional hydrogels was significantly reduced, indicating that the fluorine chain modification strategy significantly improved the adsorption selectivity of the gel materials to the PFAS, which confirmed the idea of enhancing the adsorption selectivity to the PFAS by fluorophilic effect proposed in the present application.

In the four QF gels, QF6 generally had the highest removal rates of the four PFAS, and the removal rates of PFOS, PFOA and PFBS (>99.0%) were almost unaffected by a water matrix type, indicating the potential of the gel as an efficient adsorbent for targeted removal of PFAS in water at an environmental concentration. The QF6 would be used as a typical PFAS adsorption material to verify its application performance in removing PFAS in actual water bodies in subsequent experiments.

### 6. Experiment on Influence of pH on PFAS Removal

Determination method: 100 mL of PFAS aqueous solution at a concentration of 1 μg/L was prepared in a 120 mL polypropylene sample bottle, pH values were adjusted to be 4, 6, 8 and 10 respectively, then the sample bottle was placed in a constant-temperature shaker to shake at 180 rpm and 25° C., 10 mg of QF6 was added, then samples were obtained at different interval time points, the obtained solution was filtered by a polypropylene needle filter and diluted for a certain number of times, 100 μL of supernatant was taken, and the concentration of PFAS in the supernatant was determined. A total of three parallel tests were carried out in the above experiment to ensure the accuracy of test results.

In order to study the application performance of the amine-fluoride bifunctional gel in actual water bodies with different solution acidity and alkalinity conditions, QF6 was used as a typical material to study the removal rates of the four PFAS in deionized water and lake water at a pH value ranging from 4.0 to 10.0.

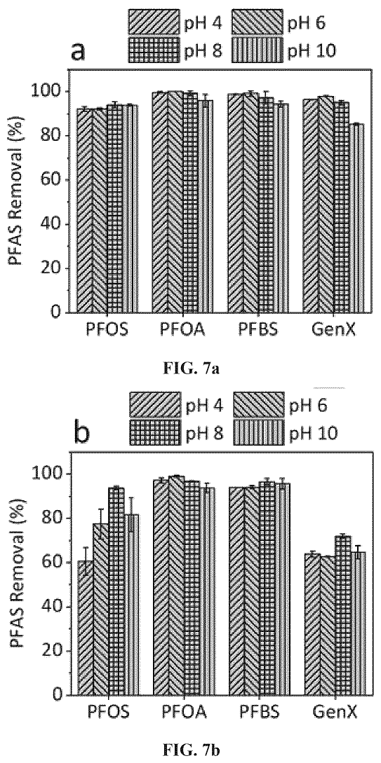

As shown in FIG. 7a, in deionized water, the removal of PFOS, PFOA and PFBS by QF6 was less affected by the pH, and the removal rates of three PFAS were all higher than 90.0% at the pH value ranging from 4.0 to 10.0. A strong alkaline condition (pH=10.0) had obvious influence on the removal rate of GenX, and the removal rate was reduced to about 85.0%.

It was worth noting that, when QF6 was used to remove the PFAS in lake water, both acidic and alkaline solutions could have great influence on the PFOS removal, wherein the removal rate of PFOS by QF6 was the highest (˜94.0%) when pH=8.0. For PFOA and PFBS, the acidity and alkalinity of solution had no obvious influence on the adsorption performance of QF6; while for GenX removal, QF6 had the best adsorption effect when pH=8.0.

### 7. Determination of Adsorption Kinetics to PFAS

Determination method: 100 mL of PFAS aqueous solution at a concentration of 15 μg/L was prepared in a 120 mL polypropylene sample bottle, then the sample bottle was placed in a constant-temperature shaker to shake at 180 rpm and 25° C., 10 mg of QF6 was added, then samples were obtained at different interval time points, the obtained solution was filtered by a polypropylene needle filter and diluted for a certain number of times, 100 μL of supernatant was taken, and the concentration of PFAS in the supernatant was determined. A total of three parallel tests were carried out in the above experiment to ensure the accuracy of test results.

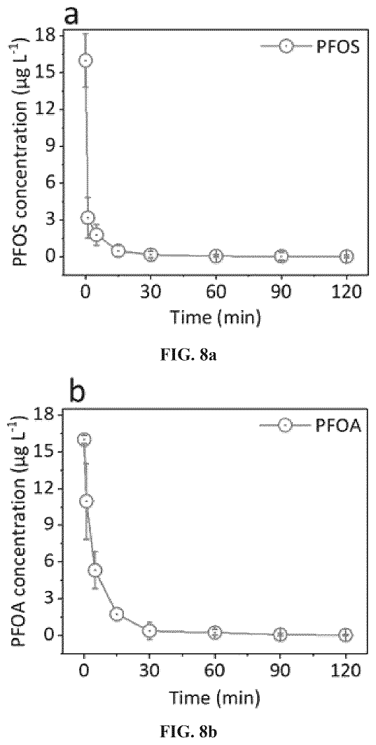

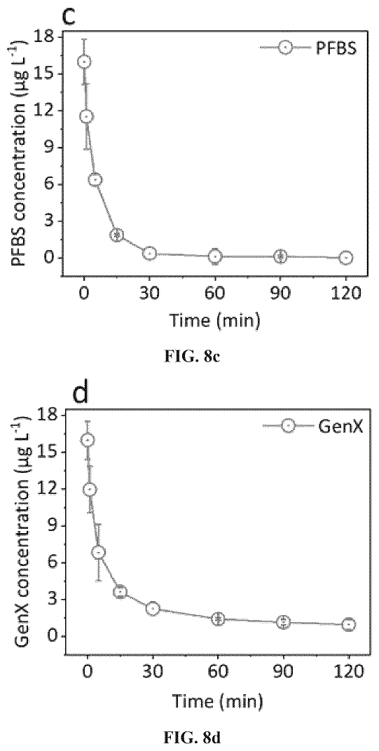

The adsorption kinetics performance of the adsorbent could affect the efficiency and operating cost of water treatment, so that the removal kinetics of four PFAS by the QF6 was further studied. Results were shown in FIG. 8a to FIG. 8d. QF6 had a fast kinetic rate for the removal of the four PFAS, wherein adsorption equilibrium time to PFOS, PFOA and PFBS was less than 60 minutes, and adsorption equilibrium time to GenX was less than 120 minutes.

### 8. Determination of Adsorption Cycle Performance to PFAS

Determination method: 10 mg of QF6 was added into a polypropylene sample bottle filled with 100 mL of 10 mg/L PFAS deionized water solution, and then the sample bottle was put into a constant-temperature shaker and shaken at 180 rpm and 25° C. for 12 hours. After the adsorption process was ended, the PFAS-adsorbed QF6 was collected by filtration and added into a polypropylene sample bottle filled with 10 mL of 10 wt % NaCl/methanol mixed solution (volume ratio: 30:70), then the sample bottle was put into a constant-temperature shaker and shaken at 180 rpm and 25° C. for 12 hours, and the eluted and regenerated QF6 was collected by filtration and washed with deionized water for 3 times for the next cycle of PFAS adsorption determination. The above adsorption-elution cycle experiment was carried out for a total of 6 times to determine the regeneration performance of the QF6 material.

The regeneration performance of the adsorbent significantly affected a treatment cost per ton of water during water treatment. Therefore, the removal effects on the four PFAS in lake water by QF6 during six cycles of adsorption-desorption were further studied.

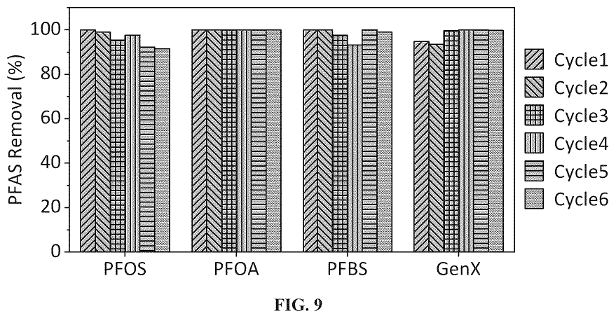

Results were shown in FIG. 9. The QF6 showed excellent PFAS adsorption and recycling performance, and the removal rates of PFOA and PFBS remained close to 100.0% after six cycles. The removal rate of PFOS by QF6 was decreased gradually with an increase of number of adsorption cycles, but the removal rate remained above 90.0% after the sixth cycle. In addition, the removal rate of GenX by QF6 was about 94.7% in the first cycle, which was gradually increased with the increase of the number of adsorption cycles, and the removal rate of GenX still exceeded 99.7% after the sixth cycle.

The above adsorption cycle experiment verified that the QF6 developed in the present application had excellent regeneration performance during cyclic PFAS adsorption, which proved that QF6 was an ideal adsorbent for the disposal of PFAS-polluted water body.

We claim:

1. A preparation method of an amine-fluorine bifunctional hydrogel adsorbent, characterized in that, comprising: uniformly mixing a fluorine-containing alkene monomer, a quaternary ammonium salt alkene monomer, a traditional Chinese medicine residue cellulose dispersion liquid, N,N′-methylene bisacrylamide and ammonium persulfate, and sequentially carrying out heating reaction, deionized water swelling and drying to obtain the amine-fluorine bifunctional hydrogel adsorbent;
the fluorine-containing alkene monomer is hexafluorobutyl methacrylate, 1H,1H,5H-octafluoropentyl methacrylate, 1H,1H,2H,2H-nonafluorohexyl methacrylate or 2,2,3,3,4,4,5,5,6,6,7,7-dodecafluoroheptyl methacrylate;
the quaternary ammonium salt alkene monomer is methacryloyloxyethyltrimethyl ammonium chloride;
the amine-fluorine bifunctional hydrogel adsorbent has a hydrophilic amine and hydrophobic fluorine dual-network interpenetrating porous structure;
a preparation method of the traditional Chinese medicine residue cellulose dispersion liquid comprises: heating a traditional Chinese medicine residue waste, potassium peroxymonosulfate and water for oxidation reaction, then stopping heating and diluting and washing with water to obtain traditional Chinese medicine residue cellulose, and dispersing the traditional Chinese medicine residue cellulose in dimethylformamide to obtain the traditional Chinese medicine residue cellulose dispersion liquid.

2. The preparation method according to claim 1, characterized in that, a molar ratio of a fluorine content in the fluorine-containing alkene monomer to a nitrogen content in the quaternary ammonium salt alkene monomer, the N,N′-methylene bisacrylamide and the ammonium persulfate is 4 to 18:2 to 6:0.065 to 0.195:0.022 to 0.088, and a molar volume ratio of the N, N′-methylene bisacrylamide to the traditional Chinese medicine residue cellulose dispersion liquid is 0.065 to 0.195 mmol:1 to 3 mL.

3. The preparation method according to claim 2, characterized in that, the temperature for the heating reaction is from 60° C. to 80° C., and the time for the heating reaction is from 2 hours to 6 hours.

4. The preparation method according to claim 2, characterized in that, the time for the swelling is from 1 hour to 3 hours, the temperature for the drying is from 50° C. to 80 ° C., and the time for the drying is from 24 hours to 72 hours.

5. An amine-fluorine bifunctional hydrogel adsorbent prepared by the preparation method according to claim 1, characterized in that, the amine-fluorine bifunctional hydrogel adsorbent has a hydrophilic amine and hydrophobic fluorine dual-network interpenetrating porous structure.

6. A use of the amine-fluorine bifunctional hydrogel adsorbent according to claim 5 in selective adsorption to a per-and polyfluoroalkyl substance.
